(19) United States
(12) Patent Application Publication
(10) Pub. No.: US 2020/0219389 A1
(43) Pub. Date: Jul. 9, 2020

(54) VISUALIZIING REAL-TIME INTERSECTION OCCUPANCY AND CALCULATED ANALYTICS IN 3D

(71) Applicant: Continental Automotive Systems, Inc., Auburn Hills, MI (US)

(72) Inventor: Jesse Aaron Hacker, West Bloomfield, MI (US)

(73) Assignee: Continental Automotive Systems, Inc., Auburn Hills, MI (US)

(21) Appl. No.: 16/735,280

(22) Filed: Jan. 6, 2020

Related U.S. Application Data
(60) Provisional application No. 62/789,799, filed on Jan. 8, 2019.

(51) Int. Cl. G08G 1/01; G06T 19/00

(52) U.S. Cl. CPC G08G 1/0145; G08G 1/0133; G06T 19/003; G08G 1/012; G08G 1/0116

(57) ABSTRACT

A method for generating a heat map of a surface area includes receiving, at a hardware processor, sensor data from one or more sensors in communication with the hardware processor and positioned such that the surface area is within a field of view of the one or more sensors. Determining, at the hardware processor, the speed and location for each of the traffic participants. Generating, at the hardware processor, a 2D map based on the traffic participants. The method also includes generating, at the hardware processor, a 3D map based on the traffic participants.

### CROSS REFERENCE TO RELATED APPLICATIONS

This U.S. patent application claims the benefit of U.S. provisional patent application No. 62/789,799, filed Jan. 8, 2019, which is hereby incorporated by reference.

### TECHNICAL FIELD

The invention relates generally to a system for detecting real time or near real time data of a traffic event, such as traffic proximate to an intersection. The system is able to be integrated into local infrastructure and is able to detect vehicles and objects which may not be readily visible to other drivers.

### BACKGROUND

Currently, there are many types of systems in place, which are part of a vehicle, to make a driver of the vehicle aware of potential objects such as pedestrians, other vehicles, and other objects along the side of a road, or on a road. However, not all vehicles are equipped with these sensors and even with all of these advances in technology, blind spots for specific vehicles can still occur.

Traffic on roads includes traffic participants, such as, but not limited to, vehicles, streetcars, buses, pedestrians, and any other moving object using public roads and walkways or stationary objects such as benches and trash cans. Organized traffic generally has well established priorities, lanes, right-of-way, and traffic control intersections. It is desirable to have a system and method for monitoring the traffic to determine traffic patterns and view spots which may be blind to some vehicles proximate to an intersection.

Accordingly, there exists a need for a system for detecting traffic an intersection based on an automated nature, which presents the information to a driver and/or user in an understandable manner.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

One general aspect includes a method for generating a heat map of a surface area. The method also includes receiving, at a hardware processor, sensor data from one or more sensors in communication with the hardware processor and positioned such that the surface area is within a field of view of the one or more sensors. The method also includes determining, at the hardware processor, the speed and location for each one of the one or more traffic participants. The method also includes generating, at the hardware processor, a 2d map based on the one or more traffic participants. The method also includes generating, at the hardware processor, a 3d map based on the one or more traffic participants.

Implementations may include one or more of the following features. The method may include overlaying the 3d map with traffic participants on an augmented reality map of the stationary objects of the intersection.

The method may include overlaying the 3d map with traffic participants on a virtual reality map of the stationary objects of the intersection.

One general aspect includes a traffic monitoring system for generating a heat map of a surface area. The traffic monitoring system also includes a hardware processor. The system also includes hardware memory in communication with the hardware processor, the hardware memory storing instructions that when executed on the hardware processor cause the hardware processor to perform operations may include: receiving, at a hardware processor, sensor data from one or more sensors in communication with the hardware processor and positioned such that the surface area is within a field of view of the one or more sensors; determining, at the hardware processor, the speed and location for each one of the one or more traffic participants; generating, at the hardware processor, a 2d map based on the one or more traffic participants. The system also includes generating, at the hardware processor, a 3d map based on the one or more traffic participants. The system also includes a display to show the 3d map.

Implementations may include one or more of the following features. The system where the operations further may include overlaying the 3d map with traffic participants on an augmented reality map of the stationary objects of the intersection.

The operations further include determining traffic participant boundaries based on the heat map, each boundary identifies traffic lanes, crosswalks, and/or pedestrian lanes of the surface area.

The sensors further may include one of: a camera, a radar, a lidar, a ladar, ultrasound, and sonar.

The sensors are secured to at least one infrastructure component, and where the at least one infrastructure component being one selected from the group may include of a building, a bridge, a parking structure, and a support structure.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present invention will become more fully understood from the detailed description and the accompanying drawings, wherein:

FIG. 1 is a schematic view of an exemplary overview of an intersection visualization system.

FIG. 2 is a diagram of a first example of an intersection having an intersection visualization system, according to embodiments of the present invention;

FIG. 3 is a diagram of a first example 3D visualization of intersection created using the intersection visualization system, according to embodiments of the present invention;

FIG. 4 is a diagram of a second example of an intersection having an intersection visualization system, according to embodiments of the present invention;

FIG. 5 is a flow diagram of an example method for implementing accident detection and warning system, according to embodiments of the present invention; and

FIG. 6 is a schematic view of an example computing device executing any system or methods described herein.

### DETAILED DESCRIPTION OF THE PREFERRED EMBODIMENTS

The following description of the preferred embodiment(s) is merely exemplary in nature and is in no way intended to limit the invention, its application, or uses.

Autonomous and semi-autonomous driving has been gaining interest in the past few years. To increase transportation safety of autonomous and semi-autonomous vehicles, it is important to have an accurate idea of the infrastructure (i.e., roads, lanes, traffic signs, crosswalks, sidewalks, etc.) that is being used by these vehicles, and know the active participants (e.g., vehicles, pedestrians, etc.) using the infrastructure. A vehicle-traffic system as described below quantifies this information as a map showing the moving flow of vehicles, pedestrians, and object in the intersection, which may be used by the autonomous and semi-autonomous vehicles to improve driving accuracy and thus transportation safety. Specifically, the map is shown as a 3D map.

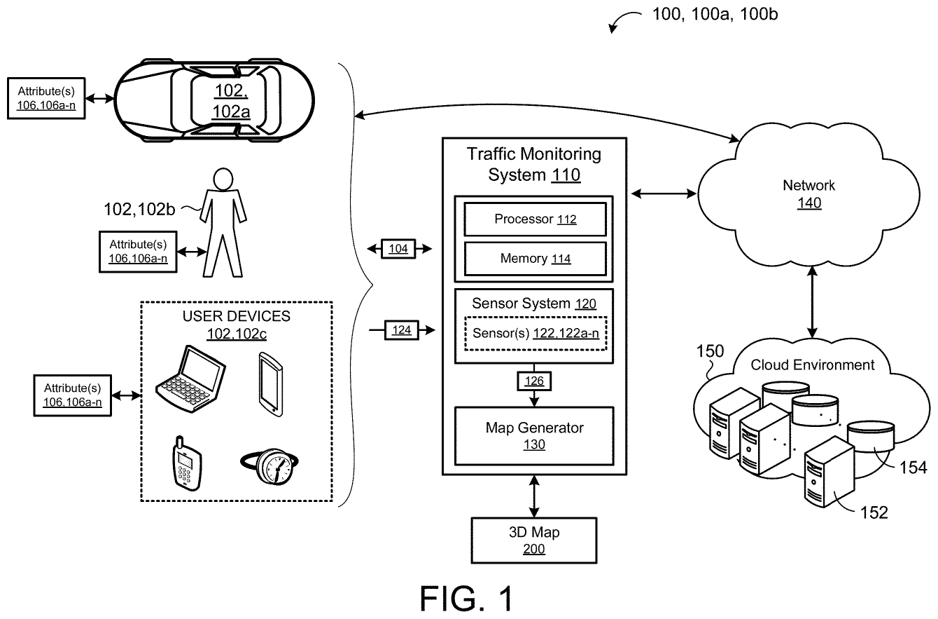

Referring to FIGS. 1-4, a vehicle-traffic system 100, 100a, 100b includes a traffic monitoring system 110 that includes a computing device (or hardware processor) 112 (e.g., central processing unit having one or more computing processors) in communication with non-transitory memory or hardware memory 114 (e.g., a hard disk, flash memory, random-access memory) capable of storing instructions executable on the computing processor(s) 112. The traffic monitoring system 110 includes a sensor system 120. The sensor system 120 includes one or more sensors 122a-n positioned at one or more roads or road intersections 10 and configured to sense one or more traffic participants 102, 102a-c. Traffic participants 102, 102a-c may include, but are not limited to, vehicles 102a, pedestrians and bicyclists 102b, user devices 102c. In some implementations, the user device 102c is any computing device capable of communicating with the sensors 122. The user device 102c may include, but is not limited to, a mobile computing device, such as a laptop, a tablet, a smart phone, and a wearable computing device (e.g., headsets and/or watches). The user device 102c may also include other computing devices having other form factors, such as a gaming device.

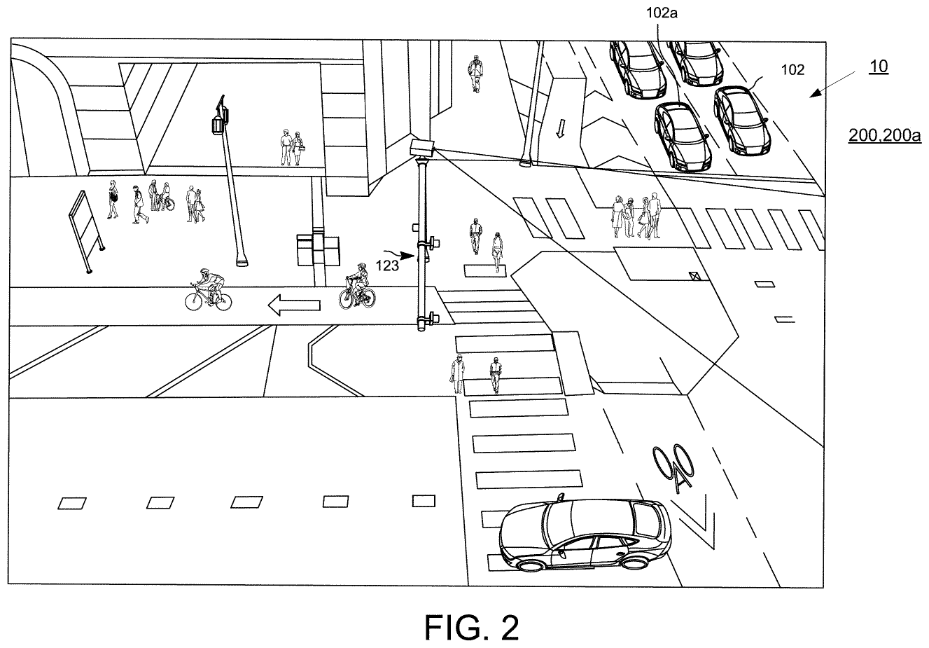

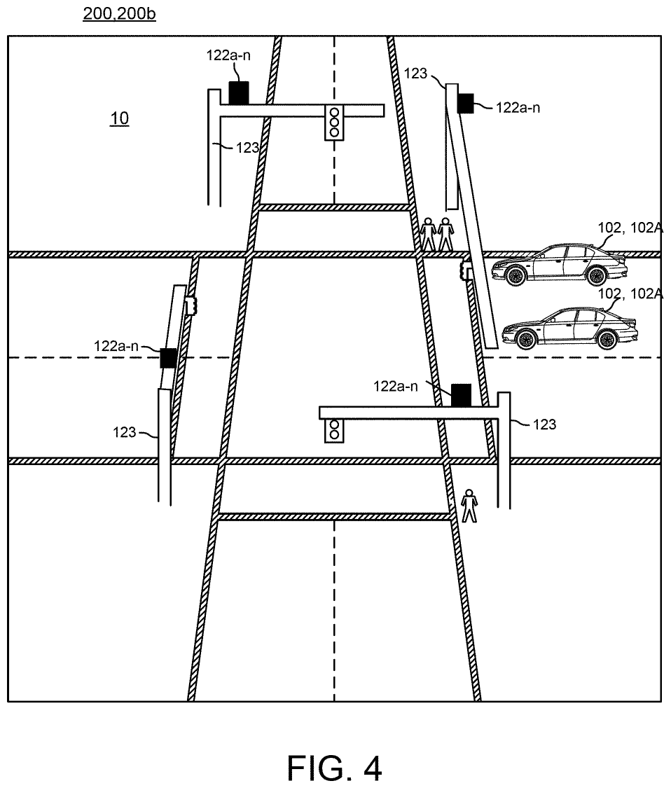

In some implementations, the one or more sensors 122a-n may be positioned to capture data 124 associated with a specific area 10, where each sensor 122a-n captures data 124 associated with a portion of the area 10. As a result, the sensor data 124 associated with each sensor 122a-n includes sensor data 124 associated with the entire area 10. In some examples, the sensors 122a-n are positioned within the intersection 10, for example, each sensor 122a-n is positioned on a corner of the intersection to view the traffic participants 102 or supported by a traffic light or other infrastructure proximate tot he intersection. In the embodiment, shown in FIGS. 2 and 4, the sensors 122a-n are mounted on a light pole, 123 of the system 100, 100a, 100b.

While in this embodiment, the infrastructure component is the post 123, it is within the scope of the invention that the visualization system 100 may include any other type of infrastructure component, such as a building, bridge, parking structure, support structure, or the like. In this embodiment, the sensors 122a-n, are integrated into a single component but it is within the scope of the invention that the sensors 122a-n may be separate components in different locations located about the intersection each having differing fields of view. The sensors 122a-n in this embodiment are able to detect objects in a detection area, shown generally at 10.

The sensors 122a-n may include, but are not limited to, Radar, Sonar, LIDAR (Light Detection and Ranging, which can entail optical remote sensing that measures properties of scattered light to find range and/or other information of a distant target), HFL (High Flash LIDAR), LADAR (Laser Detection and Ranging), cameras (e.g., monocular camera, binocular camera). Each sensor 120 is positioned at a location where the sensor 122 can capture sensor data 124 associated with the traffic participants 102, 102a-c at the specific location. Therefore, the sensor system 120 analyses the sensor data 124 captured by the one or more sensors 122a-n. The analysis of the sensor data 124 includes the sensor system 120 identifying one or more traffic participants 102 and determining one or more attributes 106, 106a-n associated with each traffic participant 102. The traffic attributes 106, 106a-n, may include, but are not limited to, the location of the traffic participant 102 (e.g., in a coordinate system), a speed associated with the traffic participant 102, a type of the traffic participant 102 (e.g., vehicles 102a, pedestrians and bicyclists 102b, user devices 102c), and other attributes of each traffic participant 102 within the area 10.

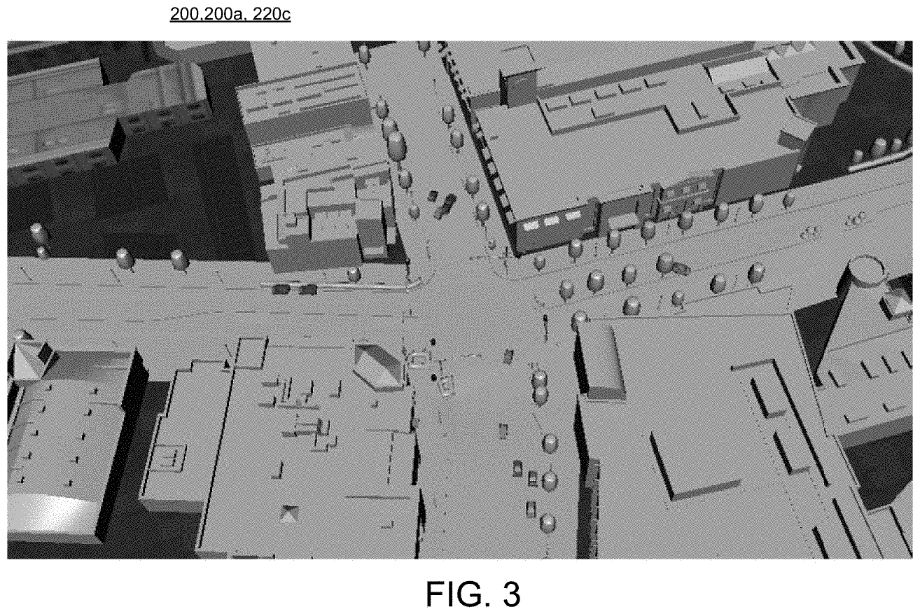

The traffic monitoring system 110 executes a map generator 130 that generates a map 200, 200a, as shown in FIG. 3, based on the analyzed sensor data 126 received from the sensor system 120. Therefore, the sensors 122a-n capture sensor data 124 associated with an area 10, such as a road or intersection, then the sensor system 120 analyses the received sensor data 124. No a-priori information about the area 10 is needed by the traffic monitoring system 110 since all relevant information, such as sensor metadata (i.e., sensor location, for example, a relative position of each sensor 122, 122a-n in a coordinate system and/or with respect to one another) associated with each sensor 122, 122a-n are known and the received sensor data 124 is captured and collected. Therefore, the traffic monitoring system 110 generates the map 200a to understand the geometry and geography of the area based on the received sensor data 124 associated with each of the sensors 122a-n.

Vehicle-to-everything (V2X) communication is the flow of information from a vehicle to any other device, and vice versa. More specifically, V2X is a communication system that includes other types of communication such as, V2I (vehicle-to-infrastructure), V2V (vehicle-to-vehicle), V2P (vehicle-to-pedestrian), V2D (vehicle-to-device), and V2G (vehicle-to-grid). V2X is developed with the vision towards safety, mainly so that the vehicle is aware of its surroundings to help prevent collision of the vehicle with other vehicles or objects. In some implementations, the traffic monitoring system 110 communicates with the traffic participants 102 via V2X by way of a V2X communication 104, and the traffic participant 102 sends one or more attributes of the traffic participant 102 to the traffic monitoring system 110 by way of the V2X communication 104. Therefore, the traffic monitoring system 110 may analyze the V2X communication to determine one or more attributes 106 associated with the respective traffic participant 102.

In some examples, the traffic monitoring system 110 is in communication with a remote system 150 via the network 140. The remote system 150 may be a distributed system (e.g., a cloud environment) having scalable/elastic computing resources 152 and/or storage resources 154. The network 140 may include various types of networks, such as a local area network (LAN), wide area network (WAN), and/or the Internet. In some examples, the traffic monitoring system 110 executes on the remote system 150 and communicates with the sensors 122 via the network 140. In this case, the sensors 122 are positioned at the intersection to capture the sensor data 124. Additionally, in this case, the traffic participants 102 may communicate with the traffic monitoring system 110 via the network 140, such that the traffic participants 102 send the traffic monitoring system 110 one or more attributes 106 associated with the traffic participant 102.

Further in regards to the embodiments described above, the communication device 24 is a DSRC device 24, or may be a 5g communication device 24, but it is within the scope of the invention that other types of communication devices maybe used.

Learning Intersection Attributes from Sensor Data

In some implementations, the map generator 130 learns patterns of traffic participants 102, 102a-c based on the analyzed sensor data 126 received from the sensor system 120 (including the attributes 106 associated with each traffic participant 102). Additionally, in some examples, the map generator 130 determines a map of the area 10 based on the analyzed sensor data 126.

The map generator 130 may divide the map 200a into cells, and cell movement is indicative of a traffic participant 102 moving from one cell to another adjacent cell. The map generator 130 identifies one or more boundaries, such as a traffic lane 210 (e.g., left, straight, right), a pedestrian lane or a sidewalk 220, a cycling lane (not shown), etc. based on the received sensor data 124. For example, the traffic monitoring system 110 may determine a boundary to be a traffic lane 210 based on a speed of the traffic participant 102 (e.g., the speed of the traffic participant 102 determined based on the sensor data 124 as one of the participant attributes 106). Moreover, the map generator 130 may identify a cycle lane based on the attributes 106 associated with each traffic participant 102. In some examples, the map generator 130 identifies a sidewalk or a crosswalk 230 where the pedestrians walk the most. In some examples, the map generator 130 determines an overlap between a portion of the traffic lanes 210 at a first time and pedestrian boundaries at a second time.

In some examples, the map generator 130 generates the map 200a and divides the map 200a into cells (not shown). Some cells may be associated with cell attributes, such as crosswalk, pedestrian traffic light, cyclist lane, vehicle lane.

Overlaying the Map onto Other Maps

In some implementations, the map generator 130 generates the map 200 based on the sensor data 124 and overlays the map 200 on other types of maps, e.g., a geographic map, a street map, an intersection map, to name a few, to enhance sensor detection and representation of objects resulting in a geographic-map 200c as shown in FIG. 2C. The traffic monitoring system 110 may use extrinsic calibration parameters associated with the sensors 120 to generate a correspondence matrix between the generated map 200a and the other types of map. For example, the extrinsic calibration parameters associated with the sensors 122 may include the location of each sensor 122 in a coordinate system which may be overlain on the geographic map. As such, the resulting map 200c (i.e., the map and the other map overlaid) shown in FIG. 2C, provides a better representation of the traffic participants 102, objects (e.g., street lights, trash cans, mail boxes, etc.), vehicle lanes 210, sidewalk 220, and crosswalks 230.

The system 100, 100 utilizes the data from the sensors 122a-n and the map generator 130 to turn the data into a 3D visualization of the intersection 10, shown in FIG. 3 (Further 3D visualization examples can be seen in the Appendix A, attached). Therefore, the visualization system 100 provides a clear and concise way to visualize important data for the infrastructure system (intersection, parking, etc.) as well as a way to use data collected and generated by the system 100. The visualization system 100 and software (in processor 112, and memory 114) utilizes data broadcast by the infrastructure (sensors 120a-n). The sensor data 126 can be real time, or previously recorded and played back. Using the data the 3D map, 200, 200a,200b is generated, including all the detected traffic participants, 102,102a,102b,102c. The system 100 is also capable of consuming generated analytics and overlaying them on the 3D map 200, 200s, 200b to visually tie data that is otherwise difficult to picture. The 3D map 200,200a,200b with overlays can be displayed on a screen, including via augmented reality displays or immersive virtual reality experience. The system 100 provides an comprehensive visualization with improved cohesiveness to the data and simplifies use of complex analytics and applications over using purely raw data.

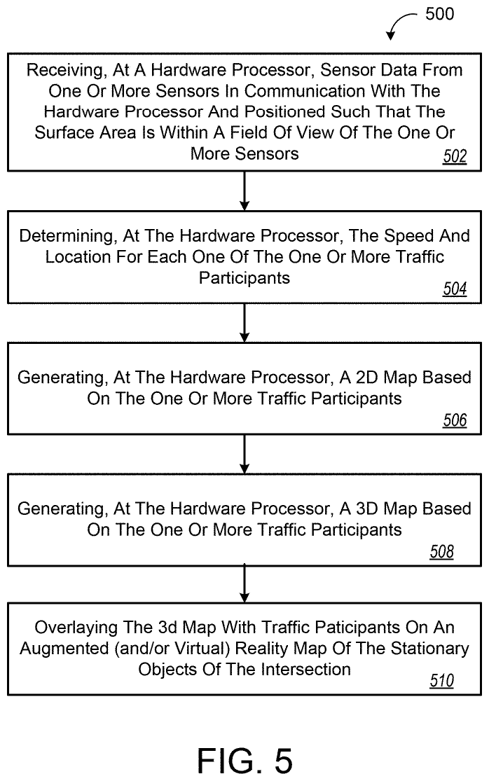

FIG. 5 provides an example arrangement of operations for a method 500 for generating a heat map of a surface area using the system 100 of FIGS. 1-2C. At block 502, the method 500 includes receiving, at a hardware processor 112, sensor data 124 from one or more sensors 122 in communication with the hardware processor 112 and positioned such that the surface area 10 is within a field of view of the one or more sensors 122. At block 504, the method 500 includes identifying, at the hardware processor 112, one or more traffic participants 102 from the sensor data 124. Additionally, at block 506, the method 500 includes generating, at the hardware processor 112, a 2D map based on the one or more traffic participants 102, 102a-c. Where the 2D map shows real time (or recorded and played back) motion of the traffic participants 102, 102a-c. Additionally, at block 508, the method 500 includes generating, at the hardware processor 112, a 3D map 200, 200a based on the one or more traffic participants 102, 102a-c as well as sensed stationary objects in the area, e.g. buildings, bushes or trees, mailboxes, etc. Where the 3D 200c map also shows real time (or recorded and played back) motion of the traffic participants 102, 102a-c.

In some implementations, the method 300 further includes dividing, at the hardware processor 112, the map 220a into a grid having one or more cells. The method 500 also includes determining, at the hardware processor 112, a probability of one of the traffic participants 102, 102a-c in a first cell moving to an adjacent second cell based on a pattern of motion of similar traffic participants.

The method may further include overlaying the map 220a over a 3D geographic map, photo, augmented reality and/or virtual reality map of the surface area 10 resulting from the sensor data, shown at block 510. The augmented reality and/or virtual reality map may be generated using the sensor data 126 as well as photos and/or geographic maps.

In some examples, overlaying the map 220a over a map of the surface area 10 includes: receiving, at the hardware processor 112, a sensor geographic location associated with each one of the one or more sensors 122, 122a-n from the one or more sensors 122, 122a-n; and identifying, at the hardware processor 112, the sensor geographic location of each one of the one or more sensors 122, 122a-n on the map 20a based on the sensor geographic location as a first set of reference points. The method 300 also includes identifying, at the hardware processor 112, the sensor geographic location of each one of the one or more sensors 122, 122a-n on the geographic map as a second set of reference points; and overlaying, at the hardware processor 112, the first set of reference points over the second set of reference points resulting in the geographic-map 220c. In some examples, the method also includes determining, at the hardware processor 112, traffic participant boundaries 210, 220, 230 based on the map 230a, where each boundary 210, 220, 230 identifies traffic lanes 210, crosswalks 230, and/or pedestrian lanes 220 of the surface area.

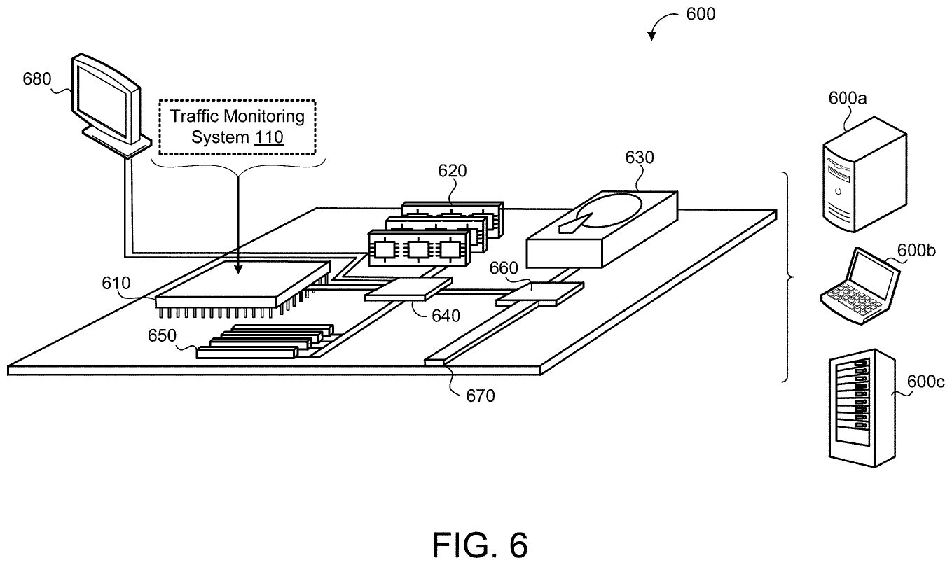

FIG. 6 is schematic view of an example computing device 400 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610, memory 620, a storage device 630, a high-speed interface/controller 640 connecting to the memory 620 and high-speed expansion ports 650, and a low speed interface/controller 660 connecting to low speed bus 670 and storage device 630. Each of the components 610, 620, 630, 640, 650, and 660, are interconnected using various busses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 620, the storage device 630, or memory on processor 610.

The high-speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and low-speed expansion port 670. The low-speed expansion port 670, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method for generating a heat map of a surface area, the method comprising:
receiving, at a hardware processor, sensor data from one or more sensors in communication with the hardware processor and positioned such that the surface area is within a field of view of the one or more sensors;
determining, at the hardware processor, the speed and location for each one of the one or more traffic participants;
generating, at the hardware processor, a 2D map based on the one or more traffic participants;
generating, at the hardware processor, a 3D map based on the one or more traffic participants.

2. The method of claim 1, further comprising overlaying the 3D map with traffic participants on an augmented reality map of the stationary objects of the intersection.

3. The method of claim 1, further comprising overlaying the 3D map with traffic participants on a virtual reality map of the stationary objects of the intersection.

4. A traffic monitoring system for generating a heat map of a surface area, the system comprising:
a hardware processor; and
hardware memory in communication with the hardware processor, the hardware memory storing instructions that when executed on the hardware processor cause the hardware processor to perform operations comprising:
receiving, at a hardware processor, sensor data from one or more sensors in communication with the hardware processor and positioned such that the surface area is within a field of view of the one or more sensors;
determining, at the hardware processor, the speed and location for each one of the one or more traffic participants;
generating, at the hardware processor, a 2D map based on the one or more traffic participants; and
generating, at the hardware processor, a 3D map based on the one or more traffic participants; and
a display to show the 3D map.

5. The system of claim 4, wherein the operations further comprise overlaying the 3D map with traffic participants on an augmented reality map of the stationary objects of the intersection.

5. The system of claim 4, wherein the operations further comprise overlaying the 3D map with traffic participants on a virtual reality map of the stationary objects of the intersection.

6. The system of claim 4, wherein the operations further include determining traffic participant boundaries based on the heat map, each boundary identifies traffic lanes, crosswalks, and/or pedestrian lanes of the surface area.

7. The system of claim 4, wherein the sensors further comprises one of: a camera, a radar, a LIDAR, a LADAR, ultrasound, and sonar.

8. The system of claim 4, wherein the sensors are secured to at least one infrastructure component, and wherein the at least one infrastructure component being one selected from the group consisting of a building, a bridge, a parking structure, and a support structure.
